(19) United States
(12) Patent Application Publication
(10) Pub. No.: US 2013/0191189 A1
(43) Pub. Date: Jul. 25, 2013

(54) NON-ENFORCEMENT AUTONOMOUS PARKING MANAGEMENT SYSTEM AND METHODS

(71) Applicants: Juan Aparicio, Blue Bell, PA (US); Mathäus Dejori, NY, NY (US); Justinian Rosca, West Windsor, NJ (US)

(72) Inventors: Juan Aparicio, Blue Bell, PA (US); Mathäus Dejori, NY, NY (US); Justinian Rosca, West Windsor, NJ (US)

(73) Assignee: Siemens Corporation, Iselin, NJ (US)

(21) Appl. No.: 13/353,441

(22) Filed: Jan. 19, 2012

(51) Int. Cl. G07B 15/02

(52) U.S. Cl. 705/13

(57) ABSTRACT

Methods and systems based on Dedicated Short Range Communications (DSRC) determine that a vehicle occupies a parking spot. A road-side system checks in the vehicle having an on-board DSRC system into a parking system. The system provides the on-board DSRC system with a parking rate and the on-board DSRC system provides the road-side system with payment data. A final parking fee is determined and is charged after the vehicle has left the parking spot. Parking rates are determined dynamically based on existing and/or expected conditions. A planning system provides a vehicle with a parking spot at a scheduled time. Navigation data is provided to the vehicle to reach the scheduled parking spot. Traffic and environmental policies are enforced by applying the methods and systems.

### BACKGROUND

Managing parking in cities is a difficult, time-consuming and labor intensive proposition today. Parking meters are typically employed. A relatively larger number of persons, who have sometimes been referred to as “meter maids,” are also typically employed to roam the city to check the parking meters and to find persons parking their cars without payment. Then the city must also employ cash collectors to collect the cash from the parking meters. Since cash is involved, the city must also provide security for the cash collectors. The resources required are quite large.

Parking in a city is not convenient to persons wishing to park either. Now a driver must first find an empty spot, then get out of the car, and then calculate and put in a desired amount of money. This assumes that the person has coins, which are usually required by parting meters. Sometimes the driver must also return to the car and put a ticket from the parking meter so that it is visible.

Central control of today's parking systems is also virtually non-existent. Cities have virtually no ability to control any of the parameters. For example, cities cannot effectively control prices. If it were desired to charge more money for busier times, cities could not effectuate such a control. These are just some of the shortcomings of today's parking systems and methods.

Accordingly, novel and improved methods and systems to manage parking systems, particularly in cities, are required.

### SUMMARY OF THE INVENTION

In accordance with an aspect of the present invention a system is provided to manage a parking spot for a vehicle with an on-board DSRC system and an on-board Global Positioning System (GPS), comprising a housing, a Dedicated Short Range Communications (DSRC) transceiver enabled to receive and transmit messages in DSRC format, a processor enabled to execute instructions to perform the steps: receiving from the on-board DSRC system of the vehicle a vehicle identifying message, determining that the vehicle has occupied the parking spot, sending a message to the on-board DSRC system of the vehicle providing a parking rate for the vehicle to occupy the parking spot and receiving vehicle data and entering into a database to determine a parking fee.

In accordance with a further aspect of the present invention a system is provided, wherein the parking fee is determined based on a current occupation of neighboring parking spots.

In accordance with yet a further aspect of the present invention a system is provided, wherein the parking fee is determined based on a congestion.

In accordance with yet a further aspect of the present invention a system is provided, wherein the parking fee is deter mined based on a characteristic of the vehicle.

In accordance with yet a further aspect of the present invention a system is provided, wherein the parking spot was made available to the vehicle based on a meteorological condition.

In accordance with yet a further aspect of the present invention a system is provided, wherein the vehicle was guided to the parking spot along a preferred route that circumvents a congestion.

In accordance with yet a further aspect of the present invention a system is provided, further comprising: the processor sending to the on-board DSRC system a message containing a check-out request.

In accordance with yet a further aspect of the present invention a system is provided, further comprising: determining that the vehicle has left the parking spot and sending to the on-board DSRC system on-board the vehicle a message containing a final parking fee.

In accordance with yet a further aspect of the present invention a system is provided, further comprising receiving from the on-board DSRC system a message authorizing a payment of a final parking fee.

In accordance with another aspect of the present invention a system on-board a vehicle is provided to park the vehicle at a parking spot under control of a Dedicated Short Range Communications (DSRC) enabled road-side system, comprising a Dedicated Short Range Communications (DSRC) transceiver enabled to receive and transmit messages in DSRC format from the road-side system, a processor enabled to execute instructions to perform the steps: sending to the road-side system a vehicle identifying DSRC message, receiving from the road-side system a DSRC message that confirms the vehicle occupying the parking spot, receiving a DSRC message from the road-side system providing a parking rate and providing vehicle data and payment authorization data to the road-side system.

In accordance with yet another aspect of the present invention a system is provided, wherein the parking fee is determined based on a characteristic of the vehicle.

In accordance with a further aspect of the present invention a method is provided for parking a vehicle at a parking spot under control of a Dedicated Short Range Communications (DSRC) enabled road-side computer system, comprising: the vehicle occupying the parking spot, a DSRC system on-board the vehicle with an on-board Global Positioning System (GPS) transmitting an identifying message to the road-side computer system, the DSRC system on-board the vehicle receiving a message from the road-side computer system including a parking rate and the DSRC system on-board the vehicle sending a message including data related to payment of a parking fee.

In accordance with yet a further aspect of the present invention a method is provided, wherein the parking fee is determined based on a current occupation of neighboring parking spots.

In accordance with yet a further aspect of the present invention a method is provided, wherein the parking fee is determined based on a congestion.

In accordance with yet a further aspect of the present invention a method is provided, wherein the parking fee is determined based on a characteristic of the vehicle.

In accordance with yet a further aspect of the present invention a method is provided, wherein the parking spot was scheduled to be occupied by the vehicle by a scheduling system.

In accordance with yet a further aspect of the present invention a method is provided, wherein the vehicle was guided to the parking spot along a preferred route to avoid a congestion.

In accordance with yet a further aspect of the present invention a method is provided, further comprising: the vehicle leaving the parking spot and the DSRC system on-board the vehicle receiving a message containing a final parking fee.

In accordance with yet a further aspect of the present invention a method is provided, further comprising collecting payment of the final parking fee.

In accordance with yet a further aspect of the present invention a method is provided, wherein the parking rate is determined based on expected conditions.

### DESCRIPTION OF THE DRAWINGS

FIG. 1 illustrates a parking management system in accordance with an aspect of the present invention.

FIGS. 2-9 illustrate conditions related to parking a vehicle in accordance with one or more aspects of the present invention;

FIG. 10 provides a block diagram of a parking system in accordance with an aspect of the present invention; and

FIG. 11 illustrates a computer system enabled to perform various steps in accordance with one or more aspects of the present invention.

### DESCRIPTION

Aspects of the present invention provide systems and methods to manage parking service in a city in an autonomous, seamless and efficient way.

In accordance with an aspect of the present invention, through direct communications between the cars and the roadside equipment (parking meter or RSE inside controller cabinet), a parked car can be automatically registered in a central database and charges collected after the car leaves the spot, with minimum effort from the driver. Various aspects of the present invention eliminates the long processing typically associated with parking-meter payments, provides control over parking resources and availability, enables a city or other controller of parking spaces to change fees dynamically, eliminates the need to know future parking time and pay a priori, reduces parking meter maintenance costs, and reduces the need for enforcement.

Aspects of the present invention also reduce parking-payment time and provide for straight-forward parking including automatic geo-location, check in and check out. The time looking for an available parking spot can be significantly reduces and, as a consequence, can reduce congestion and pollution. City revenues can also be improved with dynamic parking prices, the reduced need for enforcement workers and better knowledge of parking resources.

The methods and systems provided herein in accordance with one or more aspects of the present invention are based on a Dedicated Short Range Communications or DSRC which is known to one of ordinary skill. DSRC is a wireless communication protocol or system, mainly meant for transportation, operating in a 5.9 GHz spectrum band. DSRC systems are installed on vehicles and along roadsides. DSRC are combined with other technologies, such as Global Positioning System (GPS), Visual Light Communication (VLC), Cellular Communications (GPRS, 3G, LTE . . . ) and short range radar, allowing vehicles to communicate their position, speed, heading, relative position to other objects and to exchange information with other vehicles or external computer systems. DSRC systems can be integrated with other systems such as mobile phones.

Currently, the DSRC network is identified under the DSRC name or abbreviation. However, other names are sometimes used, usually related to a Connected Vehicle program or the like. Most of these systems are either pure DSRC or propose some variation on the IEEE 802.11a base wireless technology. DSRC is part of an Intelligent Transport System. The term DSRC will be used throughout herein. However, besides the pure DSRC system it is also meant to cover dedicated wireless communication systems between cars and roadside system which are integrated with GPS and are based on an IEEE 802.11 protocol for wireless local area networks (such as 802.11p).

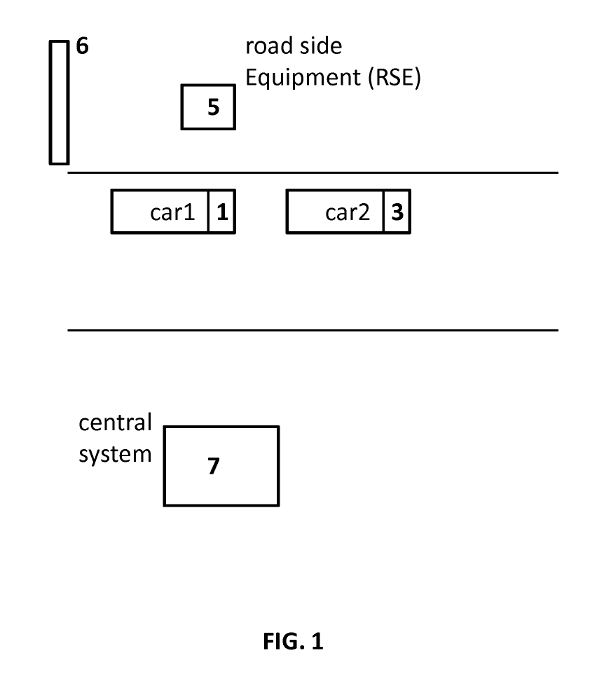

A DSRC system in accordance with an aspect of the present invention is illustrated in FIG. 1. It shows a first car ‘car1’ with an DSRC unit 1, a car‘car2’ with a DSRC unit 3, road side DSRC equipment (RSE) 5 and a central system 7. Units 1 and 3 can communicate directly with each other. Units 1 and 3 can each also communicate directly with RSE 5. A unit 1 can also communicate with 5 via unit 3. RSE 5 can communicate directly with a central system 7. Carl and cart can even communicate with the central system 7 through the cellular network (GPRS, 3G, LTE, etc.)

Preferably, no more parking meters will be used for parking spots. In one embodiment of the present invention a parking meter is replaced by or complemented with (for early deployment where not all the cars are equipped with DSRC) DSRC radios, for instance using housing that was used by ordinary parking meters. The housing is preferably located in the vicinity of the parking spots. Preferably within 50 feet of a closest parking spot, more preferably within 25 feet of a closest parking spot and most preferably closer than 10 feet to a closest parking spot.

In one embodiment of the present invention, a plurality of parking meters is replaced by a single housing that houses the DSRC roar-side equipment. For instance, housing that is used for traffic controlling equipment 6 may be used to house DSRC road-side equipment. In a further embodiment of the present invention a single dedicated housing 6 is applied to house DSRC equipment and processors and the like to manage parking spots. Such housing may also contain the required equipment to detect the occupation of a parking spot by a vehicle.

An on-board system 1 on car1 is provided with information related to the car that can be transmitted to for instance central system 7 via RSE 5. This information contains in one embodiment of the present invention information related to the car, including make, age, size, weight, type of fuel it uses, fuel efficiency, exhaust emissions, VIN, license plate number, color, and may include an image of the vehicle. The information in a further embodiment contains information related to an owner, including name, address, driving license information, age, an image of an owner and potential drivers, a driving or parking status such as licensed to occupy a handicapped parking space, emergency working status such as being a physician. Information in a further embodiment of the present invention also contains payment and/or bank information. This allows a driver to automatically pay a bill such as a parking bill.

Personal information in a further embodiment of the present invention is contained in a mobile phone or smart phone or a portable computer type of device which is enabled to communicate with the DSRC device and to provide personal information to a central system 7. Personal information related to a car, an owner of a car or a driver of a car in one embodiment of the present invention is associated with an account that resides on a central system 7 or is accessible by central system 7. Such an account may be an automatic payment account such as E-ZPass®, which automatically pays a fee, such as a parking fee or a toll fee when the account holder is detected to be at or passing a designated detection location.

In one embodiment of the present invention, a check-in of the vehicle by the RSE for parking and the receiving of payment authorizing data by the RSE from the vehicle means that the system is at that time authorized to bill the account. Once the vehicle is checked-in the system may send a message to the vehicle providing terms of the parking, conditions and rates that will be charged and potential penalties for violating parking rules and a message that states that all fees are pre-authorized for billing. The system may provide a driver a grace period to leave the parking spot before billable charges will be incurred. Such grace period may range from 30 seconds to one minute to 5 minutes or to any time considered to be reasonable as a grace period.

In one embodiment of the present invention systems and methods for DSRC based parking management are provided.

In one embodiment of the present invention through direct communications between the cars and the roadside equipment (DSRC communication point which may be located on a parking meter or in RSE inside controller cabinet), a parked car is automatically registered in a central database when a car enters a parking spot and charges collected after the car leaves the spot, with minimum effort from the driver. In one embodiment of the present invention a confirmation for parking is required from the driver. However, if a car remains parked in a parking spot after a parking request has been sent by the RSE and payment information has been received by the RSE and parking is authorized, the car is assumed to have confirmed parking by sending payment information.

In most cases a driver probably intends to park and no positive confirmation message is required. However, if payment information is withheld from the RSE and no confirmation was ent from the vehicle to the RSE, in one embodiment of the present invention the occupation of the parking spot is unauthorized. This may result in fines or other measures, including sending a request to have a tow truck remove the vehicle or an alert to a person to issue a parking violation.

This allows a parking service in for instance a municipality or a community to be managed in an autonomous, seamless and efficient way. The need for parking, the allowance of parking in an area and the scheduling of accessibility to parking as well as dynamic pricing are all aspects of a traffic policy. By providing a DSRC based automatic parking system in accordance with an aspect of the present invention an authority or community is also provided with an powerful way to enforce certain traffic, security and environmental policies, for instance.

For instance, in one scenario when a severe storm is expected and a community wants certain streets free of parked cars, the herein provided parking methods and systems can be applied to automatically inform drivers that parking is not allowed, under certain automatic penalties, such as fines or suspension of driving privileges.

In another scenario, an authority can encourage drivers to move to less congested areas for parking by setting substantially lower prices at those locations and substantially higher prices at the congested areas. Once a congestion has been resolved in an area parking pricing in that area goes down.

In one embodiment of the present invention a parking fee is applied to limit long term parking. A parking rate is incremented at regular intervals, for instance every 10 minutes. The first 10 minutes of parking may cost 25 cents, the next 10 minutes 50 cents and the next 10 minutes a dollar. The system may increase the parking rates every 10 minutes. However, the system may also keep the parking rate at one dollar for every 10 minutes. After an hour, there may be a flat fee of $20 for the next hour of parking. After 2 hours, the system will alert an enforcement unit to tow away the vehicle.

The parking rates, overall fees and parking limitations are transmitted to the on-board DSRC unit on the vehicle and preferably to a mobile communication device that is carried by the driver. This allows a system to send updates and alerts to the driver, alerting the driver for incurred fees as well as an alert that authorized parking is about to expire.

Cities like London, levy a congestion charge when driving into certain areas. The herein provided parking systems and methods allow to combine or to separate congestion and parking charges. Furthermore, in accordance with an aspect of the present invention different parking rates are charged for different type of cars. For instance a large car may be charge a large or relatively large parking fee. A small car may be charged a small parking fee and an electrical car may be charged no parking fee.

In one embodiment of the present invention, a parking fee is determined based on current occupation of neighboring parking spots. For instance, an occupation of parking spots in a range of 300 feet from a current parking spot can be applied to determine a parking fee. For instance if parking spots in a range of 300 feet are 80% occupied a 20% increase may be added to a current parking fee. If parking spots in a range of 300 feet are 95% occupied an additional 40% may be added to a current parking fee. These increases may go up if parking spots in a range of 1000 feet are highly occupied.

For instance, to keep cars out of a congested area looking for a parking spot, the parking fee may be 10 times as high as parking spots elsewhere where more spots are available.

A central system in one embodiment of the current invention maintains a record of all available parking spots and provides pricing based on where authorities would like to move traffic. A driver looking to park a car may request a listing of parking spaces that are shown on a display. The system may suggest a relatively low fee parking spot away from the center of a city and a very high fee parking spot in the center. This allows the driver to make a choice. If this choice is made early for a low fee parking spot then the driver can be guided by a navigation system around the center along a system preferred route, avoiding contributing to congestion. If the choice is made later, while already driving near or through the center, the fees for a low fee parking spot may go up as a disincentive to delay the decision.

Instead of pricing parking fees based on actual occupation of parking spots a system may also price such fees on expected occupation. For instance, a system may announce that a car parked on a parking spot at around 7 am in a business district may go up with 100% for every half hour after 7.30 am in expectation of a high demand for parking spots.

In a further embodiment of the present invention, the parking systems and methods are disclosed herein are enhanced with an on-board system that applies voice-recognition and which provides messages or data in voice or sound form to exchange information with a driver, to prevent a driver from focusing on a display rather than on traffic.

In accordance with one aspect of the present invention parking fees are determined based on the day and/or the time of day. For instance when a street with parking spots is located in a business district, parking fees are higher during business hours and are lower after business hours. Parking fees may be zero at off-peak business hours such as on Sundays or during the night.

Furthermore, a presence of DSRC receivers/transceivers throughout an area, allows a system to respond dynamically to a parking request from a small or electric car entering a congested area while denying a parking request from a large car. Such a system may keep open or unoccupied a certain number of parking spots for designated type of cars, such as electrical cars, or for designated owners of cars. Properties of a car such as size, fuel use, brand and other relevant properties are embedded in a car installed transceiver or are associated with a DSRC transceiver ID code or with a mobile communication device enabled to communicate with a DSRC receiver.

In one embodiment of the present invention methods and DSRC receivers and systems are applied to enforce traffic regulations. For instance, many cities suffer from smog problems, which are acerbated during specific meteorological conditions. In some cases this has caused authorities to only allow cars with license plates ending with even numbers to enter an area on even days to limit the number of polluting vehicles. In accordance with an aspect of the present invention driving and parking restrictions are programmed and activated in a database that is accessed through the central system 7. Detection of the cars is performed through a network of DSRC receivers and the system 7 checks if a car is authorized to drive in an area during a restricted day. During such a restricted day certain cars will not be authorized to park in the restricted area. The system 7 when an unauthorized car is detected will not assign a parking spot in a restricted area and may issue a summons or a fine or any other disciplinary action to a car or its owner when a law or regulation is violated.

It is known that high pricing of a parking spot may not address a congestion in all cases. For instance, a constant high demand for a parking spot may be experienced that may be at least partially alleviated by a scheduling mechanism. As an example, parking spots around a restaurant may be in high demand around lunch break. Also, parking spots are in high demand around places that have a high traffic and parking rate with certain peaks and valleys that could be easily smoothed by a scheduling system. In accordance with an aspect of the present invention central system 7 has access to a scheduling system that assigns and releases parking spots based on a request on behalf of a car or a mobile device that is enabled to communicate with a DSRC receiver. When a parking spot is requested around a facility well in advance a parking spot is assigned for a low fee or even free. If it is around a professional facility, such as a hospital or a government building, an appointment may be schedules based on the availability of parking spots.

For instance a person may make an appointment via a computer device and may select the need for a parking spot. If the reservation is made well in advance of the meeting the appointment is scheduled and a parking spot is assigned. Relevant data is entered into a database that is accessible by central system 7 and thus is aware of the need for a parking spot and schedules such a parking spot and allows the proper car to be parked on a spot at the proper time and for the proper fee. When somebody tries to make an appointment at a time closer to the appointment, no parking spot may be available or may be available at a much higher fee.

In accordance with an aspect of the present invention, parking scheduling is associated with a professional or governmental or any scheduling organization. For instance, a building where an appointment was scheduled has a DSRC portal. As soon as a person with an DSRC enabled computing device (or with a smart phone running an app) leaves such as building, the person is notified that the parking time expires in a certain time as the appointment has been completed. This allows the system to schedule a new occupant for the parking spot.

The DSCR enabled dynamic parking system also allows for rapid and almost universal enforcement which may be a strong deterrent to prevent unauthorized parking. For instance, unauthorized parking may schedule a very rapid engagement of a towing truck to tow away an unauthorized parked vehicle.

The DSRC parking system also allows the authorization of cars to be parked in certain parking spots. For instance, police cars and other emergency vehicles may have an automatic authorization. Certain handicapped drivers may also get a preferential authorization.

It is known that certain residential areas, for instance around venues for sports or theater events are used as parking spots. In one embodiment of the present invention residents of such areas get a preferential authorization to park their cars in their neighborhood during events.

A display 8 can be provided. The display 8 is controlled by the central system 7. The central system 7 can display information related to parking status and information, such as rates, under the control of the central system 7. It can also display other information under the control of the central system 7.

Steps or stages of DSRC based parking are described and illustrated below.

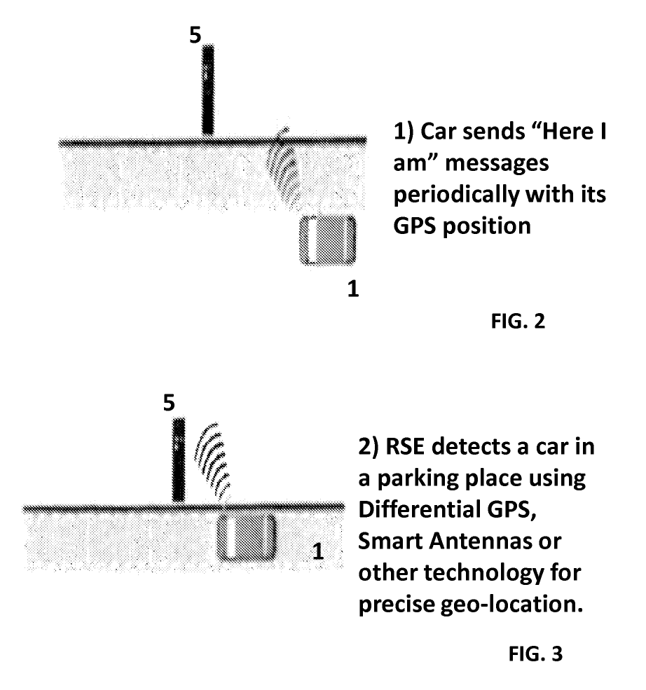

FIG. 2 illustrates a car 1 with a DSRC transceiver approaching a parking slot next to Road Side Equipment 5 with an RSE transceiver. The car 1 sends “Here I am” messages periodically with attached or included its GPS position.

FIG. 3 illustrates a situation wherein car 1 has entered the parking slot next to and/or associated with the RSE 5. The RSE 5 detects the presence of car 1 in the parking slot, for instance by using Differential GPS, Smart Antennas or any other technology for precise geo-location. The RSE 5 in one embodiment of the present invention sends an update to the central system 7.

In one embodiment of the present invention, the DSRC unit in car 1 receives a message from the RSE 5 which is displayed on a screen that alerts a driver that his car 1 occupies a parking spot for which a fee will be charged. The message may contain the cost of parking and/or a maximum time that parking is permitted. It may be that the parking spot has already been reserved for a different car, perhaps within 5 or 10 minutes from the time of the message. A message may tell the driver that the car has to be removed within a certain time frame and that a fine or other measures may be taken if the car continues to occupy the parking space.

If parking is allowed at the parking spot for the car, the car owner, through for instance an automatic charging/payment system will be notified that he is parking at a parking spot that requires payment and that he will be charged a certain rate. The rate may include a minimum charge.

Certain parking spots are reserved for short term parking, for instance for loading and unloading or for short periods of shopping. The driver is alerted of this limitation and is provided a warning about possible fines and/or towing charges. A reminder message of the expiration time for parking can be sent for instance from the central system 7 to a mobile phone of the driver.

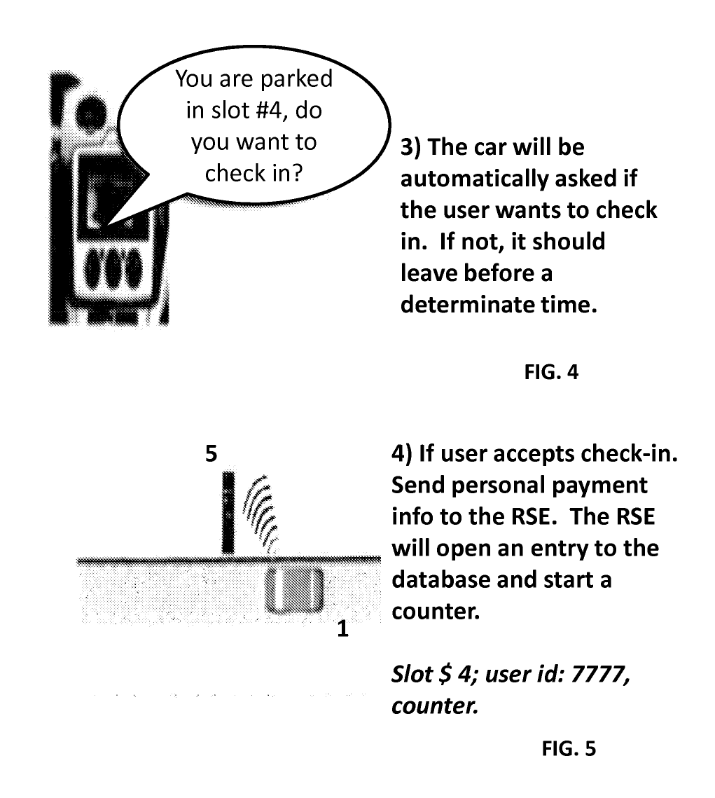

As illustrated in FIG. 4, the system may requests the driver or car if he wants to check in. In one embodiment of the present invention this requires a confirmation by the driver. In another embodiment of the present invention the driver is automatically checked in if he does not leave the parking spot with the car. FIG. 5 illustrates a situation wherein a user checks in. Check-in in one embodiment of the present invention takes place by the user confirming that he wants to occupy the parking spot. In one embodiment confirmation takes place by a user taking an action, for instance by hitting a button or an image of a button or an icon on a screen. By hitting a confirming button or icon, the car unit also sends payment information to system 5. Such payment information may be embedded in the on-board unit. It may also be entered manually by the driver.

At that time the RSE 5 will alert a system to open an entry in a database, wherein the entry is associated with a user number, for instance related to the car or to the driver who has a mobile computing device such as a cell phone. The user number is associated with a specific parking slot and a counter with keep the time that the car is parked in the specific slot to calculate a parking fee. If a parking time is exceeded an increased fee or a penalty may be levied. The system 7 may also notice that the car has exceeded the allowed parking time and alert a towing organization with specific data to tow the unauthorized car from the parking slot.

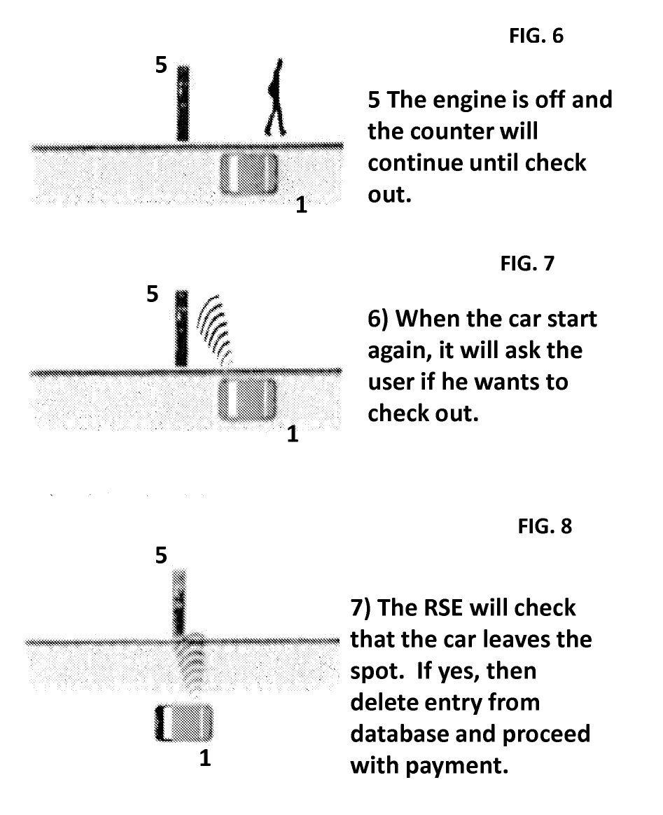

FIG. 6 illustrates the situation where the engine of the parked car is switched off. This is an indication to system 7 that the car is in a parked situation and will not leave until the engine is switched-on again. The being on/off of the engine is a condition that is provided by the on-board unit to the RSE.

FIG. 7 illustrates the situation wherein the car starts again and the system requests in one embodiment of the present invention if the driver wants to check out. In one embodiment of the present invention such a request is responded to by a driver's confirmation.

In one embodiment of the present invention, a request is confirmed by an action. For instance a check-out from a parking spot is confirmed by a vehicle leaving the parking spot. A check-in may be confirmed by a vehicle staying on a parking spot.

FIG. 8 illustrates the situation wherein the car has left the parking spot. By applying the on-board GPS the car may alert the system that it has left the parking spot. By way of differential GPS or other means the RSE may also conclude that the car has left the parking spot and will alert the central system 7 that the parking spot is available. The system in one embodiment will stop the counter for the car for calculating the parking fee after the car has left, it will complete the calculation of the fee and proceed with a payment procedure which may be an automatic payment for instance via an E-ZPass® or E-ZPass® like payment system. A confirmation of a final parking fee will be sent at least to the on-board DSRC unit of the vehicle.

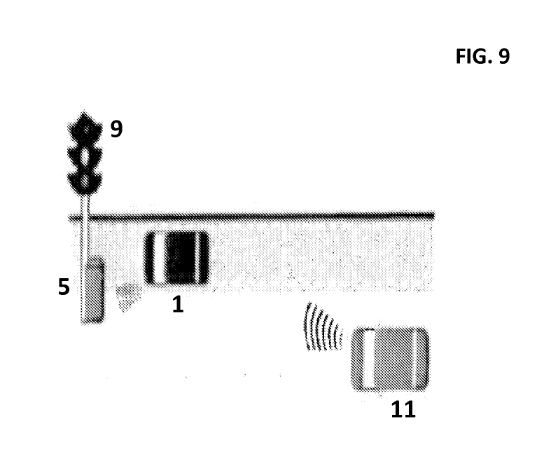

FIG. 9 illustrates the lack of parking meters when cars have DSRC units on-board and an DSRC transceiver is installed in an RSE 5 which may also contain a controller for a traffic light 9. The RSE 5 can receive DSRC signals from parked cars 1 as well as passing cars 11.

A central system 5 thus knows the number of available open parking spots or spots that will come available at a certain time. In one embodiment of the present invention a DSRC system controls parking spots on a parking lot or in a parking building. Not all parking spots are always used in an optimal way at large parking facilities. Often, a spot is open as a vehicle has left the spot but has not yet checked out of the facility. In many cases, a spot s open but is located at a remote location. In general, this causes a driver hat is entering a facility to have to search for a spot. A central system 5, in one embodiment of the present invention knows which spots are available and can guide a car with a DSRC unit to an open spot and facilitate abetter and more efficient use of available parking spots.

In a one embodiment, a central system 5 alerts a driver of a car with a DSRC unit parking facility is completely full. This prevents a driver to try to reach a (remote) parking area, only to find out that no parking spots are available. In one embodiment the DSRC unit is connected or integrated with a navigation system. The driver enters a destination into the navigation system. The navigation system also receives a request for a parking spot. The system updates the navigation system of an available parking spot at the destination and guides the car to such a parking spot. In the alternative the system 5 alerts the navigation system that no parking is available at the destination. A reservation can be made for a parking spot, an alternative parking spot may be found in the vicinity.

One problem with remote parking areas is the distance to the destination and the need for local transportation from the parking spot to the destination. Often shuttle buses are used to pick up drivers from parked cars. In one embodiment of the present invention a reservation of a parking spot on a remote location generates a request and a scheduling for a pick-up by a shuttle bus of the driver at or close to the time of parking will be generated.

In accordance with an aspect of the present invention, parking rates or even allowance to park in an area are determined dynamically based on condition in, at or around a parking spot. Conditions may include traffic conditions, such as a congestion; meteorological conditions such as concentrations of pollutants; security and emergency conditions; special event conditions such as a parade or a sports event; environmental or weather related conditions such as a flooding, obstruction of an access road, construction work and traffic obstruction of roads and parking spots. Dynamically determining parking rates for a certain day or time may be based on planned activities such as a parade or sport events or for these and other expected conditions such as a snow storm.

By considering existing conditions, the system can rapidly react by raising parking rates if there is a congestion or by prohibiting additional parking altogether. A car entering an area and requesting the system to find a parking spot may get as a response a very high rate or may be informed that no parking is allowed or available. Similarly, planned activities for a next day or rapidly changing weather conditions such as a snow storm or high smog concentration may prohibit all or certain vehicles from parking in a certain area. A central system thus can be programmed to enforce certain rules based on existing or expected conditions. For instance, for the expected smog only electrical cars may be allowed to park in a certain area and all large SUVs will be prohibited from parking, while a limited number of small cars may get a permit to park at a high parking rate.

If one is planning to enter an area within a day or so, one can request an update from the system to provide alerts on parking conditions and on parking rates. This allows drivers to plan in advanced for changed parking conditions.

The dynamically setting of rates allows the planning for conditions that are not only related to current occupation rates of parking spots.

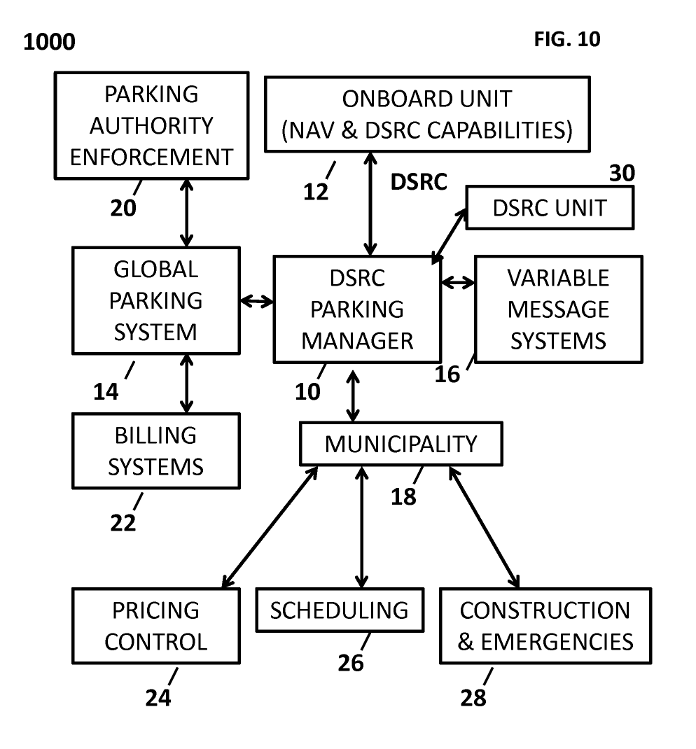

FIG. 10 furthers illustrates a parking system 1000. All components of the system communicate with each other, either directly or through other components. All components have a processor and can process and generate data and store and/or retrieve data and can exchange data with other components. The embodiment of FIG. 10 is provided for illustrative purposes only. Systems with more or with fewer components and with different components and with different connections are fully contemplated.

The system has a managing system 10 with access to databases. This system is called the “DSRC PARKING MANAGER.” However, system 10 is also programmed in one embodiment of the present invention to perform any of the tasks allocated to a central unit such as central unit 5. In one embodiment of the present invention a system 14 is the central system and may be called “GLOBAL PARKING SYSTEM.” The system has access to one or more DSRC units 30, which may be located in Road Side Equipment (RSE) units. A Parking Manager 10 in one embodiment may control one or more parking spots and contains a DSRC unit. The unit 10 communicates with an on-board DSRC unit 12 on a vehicle that has access to GPS and navigation data. A variable message system 16 provides messages to the system unit 10. The local parking manager 10 is instructed or supervised by an authority 18, which in one case may be a municipality. The authority 18 provides instructions related to parking such as price control, generated by a pricing control unit 24 a scheduling unit 26 and an exception unit 28 which determines, or overrules pricing and scheduling based on for instance construction and emergencies or special events.

Local parking management is performed under guidance of a global system 14 that manages a plurality of local systems and is able to overrule or set guidelines and local parking rules.

The system as illustrated in FIG. 10 also includes a system 20 “PARKING AUTHORITY ENFORCEMENT.” This system 20 in one embodiment of the present invention is alerted by system 10 when a car is parked unauthorized. In a further embodiment of the present invention system 20 schedules a tow truck to remove the unauthorized parked car. In another embodiment of the present invention system 20 is authorized to issue a fine and issues a fine to an owner of the unauthorized parked car. System 20 in an embodiment of the present invention also has access to records of traffic violations related to the unauthorized parked car.

The system as illustrated in FIG. 10 also includes a system 22 “BILLING SYSTEMS.” This system 22 includes several types of on-line payment systems as known. By including an authorization code in the on-board unit 12, payment of parking fees are automatically authorized when a driver checks in. System 22 may be a pre-paid system such as E-ZPass®, wherein a fee is deducted from a deposit. System 22 may also be a bank managed account wherein a fee is deducted from an account. System 22 may also be related to a credit card, wherein an authorized parking fee is charged to the credit card account. System 22 may also be another type of account such as a PayPal® account.

As described above, parking enforcement, including removing unauthorized parked cars in one embodiment of the present invention is performed automatically, by the system detecting and reporting an unauthorized parked vehicle. In one embodiment of the present invention, a complaint is filed from the vehicle when it is approaching an assigned parking spot that is occupied by another vehicle or where another vehicle occupies two parking spots. Thus, enforcement can be managed “on the go.”

In one embodiment of the present invention, the vehicle that is not authorized to park also has a DSRC on-board system. In that case, the central system is already aware of the unauthorized status. In one embodiment of the present invention the vehicle that is not authorized to park does not have a DSRC on-board system. In that case an automatic complaint can be filed to alert an enforcing authority. In a further embodiment a complaint can be filed by a driver of the authorized car that was assigned the parking spot entering identifying information of the unauthorized car, such as a license plate number and car details such as brand, and color. The complaint is included with a time stamp and a location stamp.

In one embodiment of the present invention, methods as provided herein are implemented entirely in DSRC technology. In one embodiment of the present invention methods as provided herein are implemented in different technologies of which at least one is a DSRC technology. In a combined solution another technology may be a cellular phone technology or a GPS technology or an Internet based technology. For instance, an identification of a vehicle takes place through a DSRC identification, while a payment takes place through a cellular phone.

In one embodiment of the present invention the DSRC system is applied to assign a car a parking spot and guide the car to the parking spot as described above, with as added feature that the vehicle contains a self-parking capability and the DSRC system instructs and guides the vehicle to park itself. This is useful in very tight spots. It allows the driver to exit the vehicle just before the car parks itself. It also allows a driver to recall a car from a parking spot so that the vehicle drives itself from a parking spot without immediate driver interference or instructions or operations.

It is noted that parking management in one embodiment of the present invention, is provided by instructions implemented on RSE hardware such as memory and processor. The RSE in that case is a hardware unit that is programmed or enabled to perform other applications, such us preemption, broadcast Signal Phase and Timing, green zones, data collection, emergency vehicle alert, etc. Parking is just another application running on that hardware.

In one embodiment of the present invention a driver of a vehicle books or reserves a parking spot on-line via the Internet on a website, for instance via a mobile computing device or an on-line computer connected to the Internet. A reservation website receives the parking request which is combined with a vehicle identifier, preferably a DSRC identifier. In one embodiment of the present invention such an identifier is stored and provided by the computing device. The website generates a time and date and a reserved parking spot preferably with a parking rate and sends a confirmation to the mobile computing device and to the DSRC on-board unit of the vehicle. In one embodiment, for instance when the driver uses another than the authorized vehicle, the mobile computing device with the confirmation is used to park the other vehicle in an authorized manner to the assigned parking spot. For instance, a message can be sent to the website transferring the assigned spot to the other vehicle.

In one embodiment of the present invention, vehicles that drive certain routes such as taxis, buses, mail and delivery trucks are provided with a DSRC unit and a camera such as an omni-camera or a panoramic camera or a camera that scans the parking side of the road. Images generated by these cameras can be applied to enforce parking rules. For instance, when a parking complaint is received, the system searches for vehicles with cameras that are close to and about to pass the parking spot for which a complaint was filed. The system of the vehicle with the camera is instructed to take and transmit images from the location when it passes the parking spot.

In one embodiment of the present invention, a road side unit (RSE) broadcast over a network such as the DSRC network, the number of open parking slots and/or at what time the parking slots are available. In a further embodiment of the present invention parking rates are also broadcast. The unit on the vehicle can be set with preferred selections, for instance for selecting a parking spot with a lowest parking rate or a parking spot closest to the present location of the vehicle.

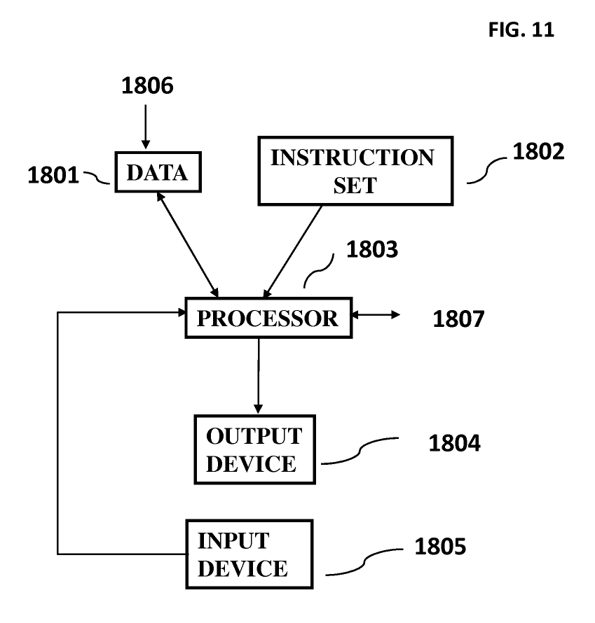

The methods as provided herein are, in one embodiment of the present invention, implemented on a system or a computer device. A system illustrated in FIG. 11 and as provided herein is enabled for receiving, processing and generating data. The system is provided with data that can be stored on a memory 1801. Data may be obtained from a GPS device or from a DSRC unit or from any other device that sends data. Data may be provided on an input 1806. Such data may be image data or positional data or pricing data or scheduling data, or any other data that is helpful in a parking system. The processor is also provided or programmed with an instruction set or program executing the methods of the present invention that is stored on a memory 1802 and is provided to the processor 1803, which executes the instructions of 1802 to process the data from 1801. Data, such as message data or any other data provided by the processor can be outputted on an output device 1804, which may be a display to display messages or a data storage device. The processor also has a communication channel 1807 to receive external data from a communication device such as a DSRC device and to transmit data to an external device, for instance in a DSRC format. The system in one embodiment of the present invention has an input device 1805, which may include a keyboard, a mouse, a pointing device, one or more cameras or any other device that can generate data to be provided to processor 1803. All of the previously described steps can be performed by the processors described herein.

The processor can be dedicated hardware. However, the processor can also be a CPU or any other computing device that can execute the instructions of 1802. Accordingly, the system as illustrated in FIG. 11 provides a parking system for data processing and is enabled to execute the steps of the methods as provided herein as an aspect of the present invention.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A system to manage a parking spot for a vehicle with an on-board DSRC system and an on-board Global Positioning System (GPS), comprising:
a housing;
a Dedicated Short Range Communications (DSRC) transceiver enabled to receive and transmit messages in DSRC format;
a processor enabled to execute instructions to perform the steps:
receiving from the on-board DSRC system of the vehicle a vehicle identifying message;
determining that the vehicle has occupied the parking spot;
sending a message to the on-board DSRC system of the vehicle providing a parking rate for the vehicle to occupy the parking spot; and
receiving vehicle data and entering into a database to determine a parking fee.

2. The system of claim 1, wherein the parking fee is determined based on a current occupation of neighboring parking spots.

3. The system of claim 1, wherein the parking fee is determined based on a congestion.

4. The system of claim 1, wherein the parking fee is determined based on a characteristic of the vehicle.

5. The system of claim 1, wherein the parking spot was made available to the vehicle based on a meteorological condition.

6. The system of claim 1, wherein the vehicle was guided to the parking spot along a preferred route that circumvents a congestion.

7. The system of claim 1, further comprising:
the processor sending to the on-board DSRC system a message containing a check-out request.

8. The system of claim 1, further comprising:
determining that the vehicle has left the parking spot; and
sending to the on-board DSRC system on-board the vehicle a message containing a final parking fee.

9. The system of claim 1, further comprising:
receiving from the on-board DSRC system a message authorizing a payment of a final parking fee.

10. A system on-board a vehicle to park the vehicle at a parking spot under control of a Dedicated Short Range Communications (DSRC) enabled road-side system, comprising:
a Dedicated Short Range Communications (DSRC) transceiver enabled to receive and transmit messages in DSRC format from the road-side system;
a processor enabled to execute instructions to perform the steps:
sending to the road-side system a vehicle identifying DSRC message;
receiving from the road-side system a DSRC message that confirms the vehicle occupying the parking spot;
receiving a DSRC message from the road-side system providing a parking rate; and
providing vehicle data and payment authorization data to the road-side system.

11. The system of claim 10, wherein the parking fee is determined based on a characteristic of the vehicle.

12. A method for parking a vehicle at a parking spot under control of a Dedicated Short Range Communications (DSRC) enabled road-side computer system, comprising:
the vehicle occupying the parking spot;
a DSRC system on-board the vehicle with an on-board Global Positioning System (GPS) transmitting an identifying message to the road-side computer system;
the DSRC system on-board the vehicle receiving a message from the road-side computer system including a parking rate; and
the DSRC system on-board the vehicle sending a message including data related to payment of a parking fee.

13. The method of claim 12, wherein the parking fee is determined based on a current occupation of neighboring parking spots.

14. The method of claim 12, wherein the parking fee is determined based on a congestion.

15. The method of claim 12, wherein the parking fee is determined based on a characteristic of the vehicle.

16. The method of claim 12, wherein the parking spot was scheduled to be occupied by the vehicle by a scheduling system.

17. The method of claim 12, wherein the vehicle was guided to the parking spot along a preferred route to avoid a congestion.

18. The method of claim 12, further comprising:
the vehicle leaving the parking spot; and
the DSRC system on-board the vehicle receiving a message containing a final parking fee.

19. The method of claim 18, further comprising:
collecting payment of the final parking fee.

20. The method of claim 12, wherein the parking rate is determined based on expected conditions.
